(19) United States
(12) Patent Application Publication
(10) Pub. No.: US 2008/0256066 A1
(43) Pub. Date: Oct. 16, 2008

(54) BOOK CREATION SYSTEMS AND METHODS

(75) Inventors: Orit Zuckerman, Tel-Aviv (IL); Sharon Kan, Lexington, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: TIKATOK INC., Lexington, MA (US)

(21) Appl. No.: 12/100,062

(22) Filed: Apr. 9, 2008

Related U.S. Application Data
(60) Provisional application No. 60/910,852, filed on Apr. 10, 2007.

(51) Int. Cl. G06F 7/06; G06F 17/30

(52) U.S. Cl. 707/5; 707/E17.014

(57) ABSTRACT

Methods and devices are provided for creating books. In general, the methods and devices are provided that can allow a child, a young adult, a senior citizen, or any other new or developing writer to create a story in an online environment including instruction and community involvement.

### CROSS-REFERENCE TO RELATED APPLICATIONS

This application claims priority to U.S. Provisional Patent Application No. 60/910,852 filed Apr. 10, 2007 and entitled “The Tikatok Book Creation System—A method and system that supports children and young adults creation of their own books,” which is hereby incorporated by reference in its entirety.

### FIELD OF THE INVENTION

The present invention relates to methods and devices for creating books, and in particular to methods and devices for supporting developing writers in electronically creating stories.

### BACKGROUND OF THE INVENTION

Creating and writing stories can help a person develop narrative voice, make sense of the world, and build an understanding of themselves. However, children and other developing writers can face one or more challenges when trying to create their own books or illustrated stories. Such challenges can include finding the courage to create a book, coming up with an idea for a story, writing the story's first line, maintaining a narrative, coming up with ideas for illustrations, and drawings pictures of things they have not drawn before. Facing such challenges, a developing writer may decide to not write a story at all, decide to not finish writing a story, or otherwise become discouraged.

Furthermore, new technologies are unleashing opportunities for people to share stories, images, and experiences. Computers can help provide a platform for learning that operates less by traditional classroom instruction and more by experimentation and trial by error by allowing children to explore and test boundaries of a system. However, people are not born with the ability to surf the Internet, create personal profiles, edit video, remix music, or otherwise navigate electronic space, nor do they know how to use electronic communities safely and responsibly. As teenagers migrate to online social networks and creative communities, it is increasingly important that they have some experience in navigating these spaces and have some understanding of their ethical responsibility to themselves and others.

Accordingly, there is a need for methods and devices for providing children and other developing writers with electronic tools to write books.

### SUMMARY OF THE INVENTION

The present invention generally provides methods and devices for creating books, and in particular to methods and devices for supporting developing writers in electronically creating stories. In one aspect, a digital device is provided that includes a processor configured to execute instructions and a memory storing instructions capable of causing the processor to identify a user with user information. Using the user information, the processor can select at least one story plot outline from a first library of data including a plurality of story plot outlines and select at least one story detail element from a second library of data including a plurality of story detail elements that can be used in a story plot. The processor can also provide the at least one story plot and the at least one story detail element to the user to allow the user to create a story using the at least one story plot and the at least one story detail element. In some embodiments, the at least one story plot and the at least one story detail element can be provided to the user over at least one network.

The memory can store a variety of other instructions for the processor. For example, the memory can store instructions capable of causing the processor to assess a learning level of the user, wherein the user information includes the learning level of the user. As another example, the memory can store instructions capable of causing the processor to select at least one instruction from another library of data including a plurality of instructions instructing a user how to incorporate a selected story detail element into a selected story plot and/or at least one drawing instruction from still another library of data including a plurality of drawing instructions regarding story illustrations, and to provide the at least one instruction and/or drawing instruction to the user. The at least one instruction and/or drawing instruction can correspond to a learning level of the user. As yet another example, the memory can store instructions capable of causing the processor to allow the user to add at least one illustration to a story created by the user. As still another example, the memory can store instructions capable of causing the processor to allow accessibility of a story created by the user through a website associated with the processor.

The user information can include a variety of types of information. For example, the user information can include active identification information regarding a user input at a client terminal in electronic communication with the processor. The active identification information can include at least one of an age of the user, a grade level of the user, a gender of the user, and a favorite book of the user. For another example, the user information can include passive identification information regarding a user's use of a website associated with the processor. The passive identification information can include at least one of a complexity of a book created by the user, a number of books created by the user using the website, and a number of times at least one other user has accessed through the website a book created by the user. The memory can store instructions capable of causing the processor to generate a summary report of the passive information and/or to determine the complexity of the book created by the user based on at least one of book length, a vocabulary level of the book, a ratio between text provided by the user and text provided to the user, and a density of paragraphs in the book. In some embodiments, the memory can store instructions capable of causing the processor to display the summary report on a graphical user interface.

In another aspect, a method is provided that includes receiving active identification information regarding a user, gathering passive identification information regarding the user, and, using the active and passive identification information, generating an outline for a story using a processor in electronic communication with the client terminal. The active identification information includes information regarding the user input at a client terminal through a website, and the passive identification information includes statistics regarding the user's use of the website. The method also includes providing the outline to the user through the website and allowing the user to create a story using the outline.

The method can have any number of variations. For example, the method can include, using the active and passive identification information, selecting at least one story element that can be inserted into the outline and providing at least one instruction to the user regarding incorporation of the at least one story element into the outline. As another example, the method can also include generating a user profile using the active and passive identification information and using the user profile to generate the outline for the story. The user profile can include a learning level and/or a taste profile of the user. The learning level of the user can be based on at least one of an age of the user, a grade level of the user, a complexity of a book created by the user, a number of books created by the user using the website, and a number of times at least one other user has accessed through the website a book created by the user. The taste profile of the user can be based on at least one of a subject of a book created by another user and accessed by the user through the website, a book identified as a favorite book of the user, a subject of a book created by the user, and a number of illustrations in a book created by the user.

### BRIEF DESCRIPTION OF THE DRAWINGS

The invention will be more fully understood from the following detailed description taken in conjunction with the accompanying drawings, in which:

FIG. 1 is a schematic diagram of an embodiment of a book creation system;

FIG. 2 is a schematic diagram showing relationships between various elements in the book creation system of FIG. 1;

FIG. 3 is a schematic diagram showing other relationships between various elements in the book creation system of FIG. 1;

FIG. 4 is a flowchart showing an embodiment of a book creation process;

FIG. 5 is an embodiment of a new user registration screen that can be used in the book creation process of FIG. 4;

FIG. 6 is an embodiment of an initial story creation screen that can be used in the book creation process of FIG. 4;

FIG. 7 is an embodiment of a story ideas screen that can be used in the book creation process of FIG. 4;

FIG. 8 is an embodiment of a story prompts screen that can be used in the book creation process of FIG. 4;

FIG. 9 is a flowchart showing embodiments of online and offline book editing processes that can be used in the book creation process of FIG. 4;

FIG. 10 is an embodiment of a printed book page that can be used in the book creation process of FIG. 4;

FIG. 11 is an embodiment of an online book page that can be used in the book creation process of FIG. 4;

FIG. 12 is an embodiment of an online cover editing page that can be used in the book creation process of FIG. 4;

FIG. 13 is an embodiment of another online book page that can be used in the book creation process of FIG. 4; and

FIG. 14 is an embodiment of still another online book page that can be used in the book creation process of FIG. 4.

### DETAILED DESCRIPTION OF THE INVENTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

The present invention generally provides methods and devices for creating books, and in particular to methods and devices for supporting developing writers in electronically creating stories. In general, the methods and devices are provided that can allow a child, a young adult, a senior citizen, or any other new or developing writer to create a story in an online environment including instruction and community involvement.

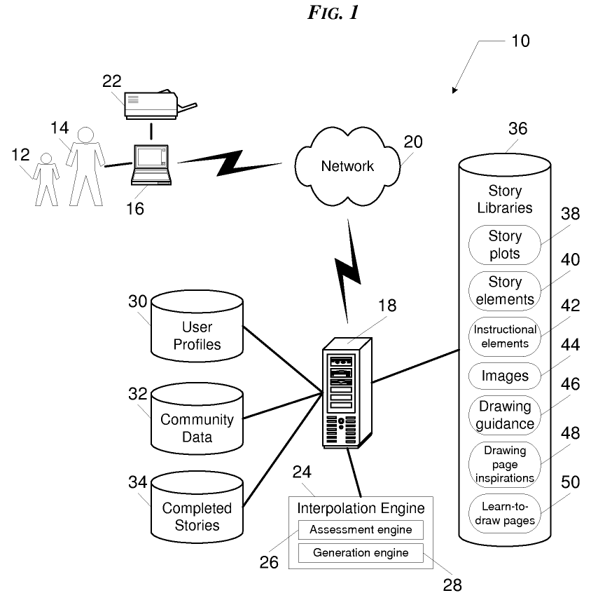

FIG. 1 illustrates one embodiment of a system 10 that can allow a user to create a book. While the user can include any person desiring to write a book, in an exemplary embodiment, the user is new or developing writer, such as a child 12. The child 12 can receive assistance from an adult 14, e.g., a parent, a grandparent, a teacher, an older sibling, etc., in creating a book. Through a client terminal 16, the child 12, optionally with assistance from the adult 14, can electronically communicate via a website or other interface with a processing server 18 over at least one network 20. Generally, the processing server 18 can guide the child 12 through the process of creating a story, including story text and/or story illustrations, while allowing the child 12 to maintain imaginative control by providing instruction and guidance through the creative bookwriting process without dictating main story plot or influencing the child 12 toward a specific graphic style for the illustrations. When the child 12 has completed a book or at any point wishes to see a tangible product of the bookwriting process, the child 12 and/or the adult 14 can print a book or a partially completed book using a laser printer 22 or any other printing device configured to communicate with the client terminal 16.

The client terminal 16 can include any mechanism or device, or combination thereof, configured to communicate with the processing server 18 through the network 20. Examples of the client terminal 16 include a workstation, a stationary personal computer, a mobile personal computer, a server, a personal digital assistant, a pager, a telephone, and other similar mechanisms and devices as will be appreciated by a person skilled in the art. Although only one client terminal is shown in the system 10, the system 10 can include a plurality of client terminals, each associated with one or more users, that can simultaneously or consecutively access the processing server 18 through the network 20.

The processing server 18 can include any mechanism or device, or combination thereof, configured to communicate with the network 20 such as a file server, an application server, a database server, a mobile computer, a stationary computer, or other similar mechanism or device as will be appreciated by a person skilled in the art. The processing server 18 can include a processor or any combination of processors configured to process instructions, e.g., a central processing unit, a microprocessor, a digital signal processing unit, application specific integrated circuits (ASICs), a state machine, an analog computer, an optical or photonic computer, logic circuitry, etc., as will be appreciated by a person skilled in the art. The processing server 18 can also include a memory configured to store and provide instructions to the processor. The memory can include any one or more storage mechanisms. Examples of the memory include random access memory (RAM) such as dynamic RAM or static RAM, read only memory (ROM), flash memory, tapes, disks, buffers, and other types of similar storage mechanisms as will be appreciated by a person skilled in the art.

The network 20 can include any network, or combination thereof, as will be appreciated by a person skilled in the art, such as an Internet, a local area network (LAN), a wide area network (WAN), a private network, a public network, or other similar network. Communications through the network 20 can be secured with a mechanism such as IP security (IPsec), Transport Layer Security/Secure Socket Layer (TLS/SSL), wireless TLS (WTLS), secure Hypertext Transfer Protocol (S-HTTP), or other similar security mechanism as will be appreciated by a person skilled in the art.

The system 10 can include more or fewer elements from those shown, such as one or more storage mechanisms (caches, memories, databases, buffers, etc.), bridges, chipsets, graphics mechanisms, display devices, I/O devices, communication links (buses, wireless links, etc.), and other similar types of elements that can be included in a system as will be appreciated by a person skilled in the art. I/O devices generally include devices configured to transfer data into and/or out of a system, such as mice, keyboards, printers, display devices such as monitors, touch pads, styluses, disk drives, graphics devices, joysticks, paddles, Zip drives, scanners, CD drives, DVD drives, modems, cameras, video devices, microphones, and other similar types of internal, external, and internal/external devices, as will be appreciated by a person skilled in the art.

Furthermore, the methods and devices described herein are not limited to any particular hardware or software configuration; they can find applicability in any computing or processing environment. The methods and devices can be implemented in hardware, software, or a combination of the two. The methods and devices can be implemented in programs executing on programmable machines such as mobile computers, stationary computers, personal digital assistants, and similar devices, as will be appreciated by a person skilled in the art, that each include a processor, a storage medium readable by the processor (including volatile and non-volatile memory and/or storage elements), and at least one input and/or output device. Program code can be applied to data entered using the input device to perform the functions described and to generate output information. The output information can be applied to one or more output devices.

Each program can be implemented in a high level procedural or object oriented programming language to communicate with a machine system. However, the programs can be implemented in assembly or machine language, if desired. In any case, the language can be a compiled or interpreted language.

Each such program can be stored on a storage medium or device, e.g., compact disc read only memory (CD-ROM), hard disk, magnetic diskette, or similar medium or device, as will be appreciated by a person skilled in the art, that can be readable by a general or special purpose programmable machine for configuring and operating the machine when the storage medium or device is read by the computer to perform the procedures described herein. The system can also be considered to be implemented as a machine-readable storage medium, configured with a program, where the storage medium so configured causes a machine to operate in a specific and predefined manner.

The processing server 18 can include a variety of mechanisms and/or devices integrally formed with the server 18 or otherwise accessible to the server 18 to help the server 18 guide the child 12 through a book creation process. The server 18 can include an interpolation engine 24 configured to process instructions related to various aspects of the book creation process using statistical analysis and/or rules based processing, as will be appreciated by a person skilled in the art. Although the interpolation engine 24 is shown server-side at the server 18, the interpolation engine 24 can be located client-side at the client terminal 16, e.g., as a program installed from a CD or a downloaded source. If the interpolation engine 24 is located client-side, the child 12 can create the book at least partially offline and communicate over the network 20 with the server 18 for certain aspects of the book creation process, e.g., access to one or more libraries, request professional printing, upload to a community, etc.

The interpolation engine 24 can include an assessment engine 26 and a generation engine 28, each configured to process information related to aspects of the book creation process, as discussed further below. The server 18 can also be configured to have access to one or more databases of information, such as a user profile database 30 including user profile information related to one or more users, a community database 32 including statistics and other information related to user interaction with the website associated with the server 18, a completed stories database 34 including books written by users and accessible through the website associated with the server 18, and a libraries database 36. The libraries database 36 can include one or more databases having information related to various aspects of helping a user create a story, including textual and/or illustration assistance. In an exemplary embodiment, the libraries database 36 can include a story plots library 38 including a plurality of pre-written parts of stories generally considered story skeletons, a story elements library 40 including a plurality of story details that can be incorporated into a story plot, a writing guidance or instructional elements library 42 including pre-written directions and suggestions for a user related to potential story development for adding original story text to a story skeleton, an images library 44 including pre-drawn clip art and/or other illustrations that a user can incorporate into a story, a drawing guidance library 46 including pre-written directions and suggestions for a user related to potentially drawing contents of one or more story elements, a drawing page inspirations library 48 including pre-drawn clip art, partially completed drawings, and/or other illustrations that can be provided to a user as a plurality of example drawings related to one or more story elements to help a user draw new, previously undrawn elements, a learn-to-draw pages library 50 including step-by-step drawing instructions for specific types of drawings (e.g., a person, an animal, an object, etc.), and/or any other similar libraries of information as will be appreciated by a person skilled in the art.

The various databases and libraries configured to be accessible by the server 18 can each have a variety of configurations that are the same or different from any one or more of the other databases in the system 10. Examples of the databases and libraries include a database, a data queue, a buffer, a local or remote memory device, random access memory (RAM), a cache, or other similar collection of data as will be appreciated by a person skilled in the art. Furthermore, as will be appreciated by a person skilled in the art, the databases and libraries can have any organizational scheme, can be separated and combined in any way, and can be located local to or remote from the server 18.

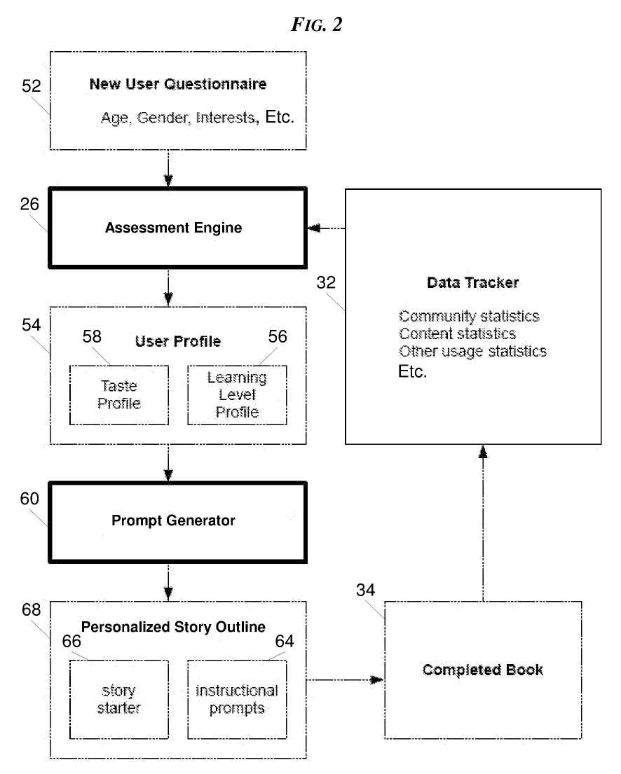

Generally, the book creation process using the server 18 can include a tracking or evaluation stage, a personalization stage, and a reporting stage. In the tracking stage, the server 18 can create a user profile for the child 12. Creating the user profile can be a singular event, and/or its creation can be an on-going, dynamic process such that the child's user profile changes over time as the child 12 ages, writes books, interacts with other users through the website associated with the server 18, reads books written by other users, and otherwise learns and changes. As illustrated in FIG. 2, the server 18 can receive initial information regarding the child 12, e.g., active or identification information entered in a new user questionnaire 52 at the client terminal 16, e.g., in an online fillable form. The new user questionnaire 52 can ask the child 12 for various types of identification information, such as age, gender, grade level, interests (e.g., favorite books, sports, pets, etc.), geographic location, login name, website password, and/or other types of identification information as will be appreciated by a person skilled in the art. For safety, the adult 14 can be required to enter or authorize entering of information for the child 12. In an exemplary embodiment, the new user questionnaire 52 is filled out by users who have not previously created a book through the server 18, although all or a portion of the new user questionnaire 52 can be filled out by any user at any time. The information entered via the new user questionnaire 52 can be communicated to the server 18 via the network 20 for addition to the child's user profile 54 in the user profile database 30.

The assessment engine 26 can process the identification information received via the new user questionnaire 52 and include results of the processing in the child's user profile 54. For example, the assessment engine 26 can make an educated guess regarding the child's storytelling ability and record a measure of the storytelling ability in a learning level profile 56, which can be part of the user profile 54. The learning level profile 56 is generally a best-guess approximation that can, but does not necessarily, reflect how much assistance a user may need to create a story with the kind of structure recognized by adults as “complete.” The learning level profile 56 can include a qualitative and/or quantitative measurement, such as keywords and/or a number ranging from one to ten, with one indicating a low learning level (e.g., a very young user) and ten indicating a high learning level (e.g., an experienced user over “X” years of age or having completed “Y” years of school). The assessment engine 26 can evaluate the child's activity to determine if the child 12 has completed certain tasks, such as reading a certain number of books, writing a certain number of books, writing a story having a certain number of words, and/or met other evaluation metrics. If the child 12 has completed certain tasks, the child's learning level profile 56 can be adjusted upward as appropriate. As another example, the assessment engine 26 can evaluate the child's indicated interests and reflect those interests as a qualitative and/or quantitative measurement in a taste profile 58 included in the user profile 54. The taste profile 58 can generally reflect a user's taste in books (reading and/or writing), such as book subject matter, complexity (e.g., book length, ratio of text versus illustrations, ratio between text provided by the child 12 and text provided to the child 12 by the server 18, vocabulary level, paragraph density, number of images, etc.), productivity (e.g., a number of books written by the child 12 online and/or offline, a number of books read by the child 12 online and/or offline, a number of comments made on books written by other users, a number of images uploaded to the server 18, a number of book recommendations made through the website associated with the server 18, a number of books shared by the child 12 through the website associated with the server 18, etc.), and public value (e.g., a number of times books created by the child 12 are read, commented on, recommended by, and/or shared by other users, etc.).

The user profile 54, including the learning level profile 56 and/or the taste profile 58, can dynamically change as the child 12 creates books, reads books, and/or otherwise visits or uses the website associated with the server 18. Such statistics regarding the child's dynamic use of the website and/or other users' evaluation of books created by the child 12 can be stored in the community database 32 and evaluated by the assessment engine 26 for inclusion in the child's user profile 54. In this way, the server 18 via the assessment engine 30 can track and analyze behavior of the child 12 with passive information over time to build, alter, and/or add to the child's user profile 54 and to assess the child's learning and writing progress.

In the personalization stage of the book creation process, the server 18 via a prompt generator 58 can help create a story outline for the child 12 that the child 12 can use to write a book. The prompt generator 58 can customize the story outline for the child 12 using the child's user profile 54. In this way, the child 12 can receive storytelling assistance correlating to the child's learning level profile 56 and/or story content tailored to the child's taste profile 58. Because the user profile 54 can dynamically change as the child 12 writes stories and interacts with the website associated with the server 18, a story outline provided to the child 12 can change in content and/or instructional level as the child 12 changes interests as reflected in the taste profile 58 and/or as the child 12 becomes more experienced, e.g., increases in learning level.

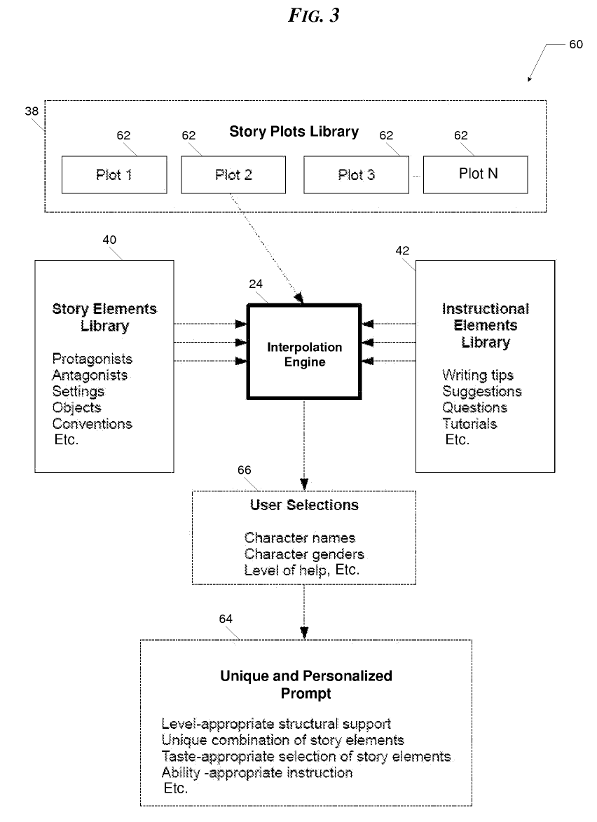

As shown in one embodiment of a prompt generator in FIG. 3, the prompt generator 60 generally involves the interpolation engine 24, e.g., the generation engine 28, accessing information in the libraries database 36 and/or the user profile, community, and completed stories databases 30, 32, 34 and, based on at least a portion of the accessed and gathered library and/or database information, creating a story outline to be provided to the child 12 from the server 18 to the client terminal 12. The interpolation engine 24 can create a story outline including a story plot, at least one story element to be included in the story plot, and at least one instruction to help guide the child 12 in fleshing out the story plot using the story element and/or using the child's imagination. To determine a story plot, the interpolation engine 24 can query the story plots library 38 for one or more of “N” plots 62 included in the story plots library 38. Generally, each of the plots 62 can include a story skeleton, e.g., a content-agnostic story framework having a structure with a story beginning, a story middle, and a story end. Each of the plots 62 can be associated with a particular learning level such that only plots 62 associated with a learning level appropriate for the child 12 can be selected for the child 12 by the generation engine 28. For example, a plot having a learning level of six can be selected for a user having a learning level of six or higher. Optionally, to encourage learning and growth, a plot having a learning level higher than the user's current learning level can be chosen by the generation engine 28. Each of the plots 62 can additionally or alternatively be associated with one or more keywords or other indicators corresponding to one or more elements of a user's taste profile. In this way, the generation engine 28 can select one or more of the plots 62 by matching them with the user's taste profile 58.

To determine at least one story element to be provided to the child 12, the generation engine 28 can query the story elements library 40 for one or more story elements. In an exemplary embodiment, the generation engine 28 consults the story elements library 40 following selection of one or more of the plots 62 from the plots library 38 and/or following the child's selection of one particular plot 62 to help select the most appropriate story elements for the plot(s) 62. Generally, story elements in the story elements library 40 can include character types (e.g., antagonists, protagonists, heroes, villains, etc.), settings (e.g., a castle, a forest, a school, outer space, a zoo, a circus, a mall, etc.), objects (e.g., princess elements, dinosaur elements, school elements, cowboy elements, birthday elements, etc.), conventions (e.g., story introductions, story climaxes, story conclusions, etc.), and other similar types of story details. Similar to that discussed above regarding the story plots 62, the story elements in the story elements library 40 can be associated with a learning level and a taste profile to help provide the child 12 with the most relevant and enjoyable story elements.

To determine at least one instructional element to be provided to the child 12, the generation engine 28 can query the instructional elements library 42 for one or more instructional elements 64 to be provided to the child 12. In an exemplary embodiment, the generation engine 28 consults the instructional elements library 42 following selection of one or more of the plots 62 from the plots library 38, following the child's selection of one particular plot 62 and/or one or more story elements from the story elements library 40, to help select the most appropriate instructions for a selected story and selected story element(s), which can collectively be called a story starter 66. The story starter 66 can also include user selections related to a story plot 62 and/or to one or more story elements, such as a character name, a character gender, a level of preferred instructional assistance, and other similar types of story customization selections. Generally, instructional elements in the instructional elements library 42 can include writing tips (e.g., word choice, punctuation, etc.), suggestions (e.g., prompts regarding what to write next), evocative questions, tutorials, and other similar types of storytelling instructions addressed to the user. Similar to that discussed above regarding the story plots 62, instructional elements in the instructional elements library 42 can be associated with a learning level and a taste profile to help provide the child 12 with the most easily understood and most effective instructions.

The story starter 66 and the instructional elements 64, collectively a story outline 68, can be provided by the server 18 to the child 12 at the client terminal 16 via the network 20. As discussed further below, the child 12 can use the story starter 66 and the instructional elements 64 to create a story, which can then be included in the completed stories database 34, where it can be accessed by at least the child 12. If the child 12 does not finish writing a story, a partially completed story can be saved in the completed stories database 34 for future editing.

In the reporting stage of the book creation process, the server 18 via the interpolator 24 can generate a report summarizing the child's taste profile 58, learning level profile 56, and/or overall user profile 54. The server 18 can store the child's report in the user profiles database 30 and can transmit the report to the client terminal 16 via the network 20. The report can be provided in a variety of ways, such as via electronic mail or by displaying the report on a graphical user interface (GUI). The adult 14 and/or the child 12 can access the report to help track the child's educational progress over time.

In an exemplary embodiment, the adult 14 and the child 12 can each view the report in different ways and/or with different information to help best communicate the report. For example, the adult 14 can receive report information in a dashboard, a visualization showing how the child 12 has advanced their learning over time with facts, charts, and/or graphs and with references to state or national learning standards. The dashboard can be organized into categories of productivity (e.g., how often the child 12 writes, how often the child 12 reads stories written by other users, etc.) and public value (e.g., how many other users have read or commented on a story written by the child 12, how many posts on a message board associated with the website discuss a story written by the child 12, etc.) to better help the adult 14 assess the child's activity and learning. The dashboard can also include a hints category that includes tips regarding the book creating process and the child's involvement in the process, such as how the adult 14 can read stories written by the child 12 and/or other users and analyze productivity and public value information in the dashboard to form a more qualitative picture of the child's progress. True educational levels and creative storytelling ability can be difficult to quantify, but the report can help the adult 14 assess the child's learning and guide the child 12 with offline instruction and support.

As another example, the child 12 can receive report information in a more game-like format. In a game-like format, the child 12 can view their report as a score representing various elements in one or more of the databases and libraries and analyzed by the interpolation engine 24, e.g., the child's learning level, the number of stories written by the child 12, the number of stories written by other users and read by the child 12, etc. The score can be numeric, alphabetic, pictorial (e.g., a number of stars, an animated creature that grows and differentiates into different animal forms parallel to the user's experiences, etc.), or otherwise represented. Scores can correspond to points that the child 12 can spend on virtual items (e.g., avatars, avatar accessories, etc.) in a virtual store. In this way, the child 12 can be further motivated to continue learning, writing, reading, and using the website associated with the server 18.

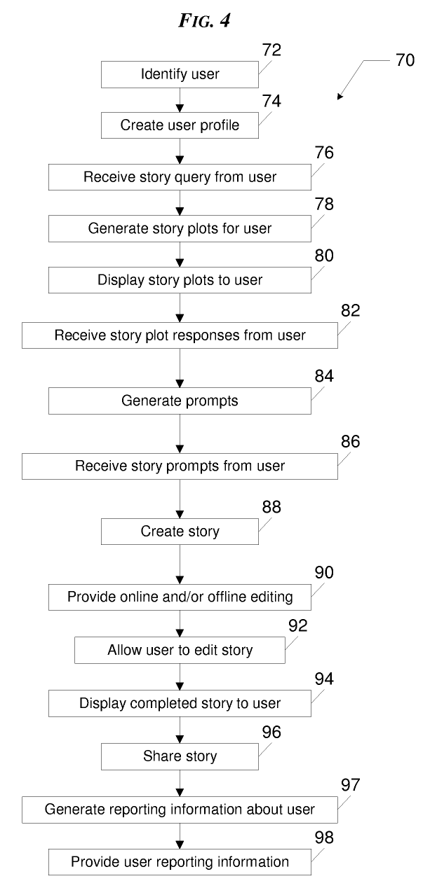

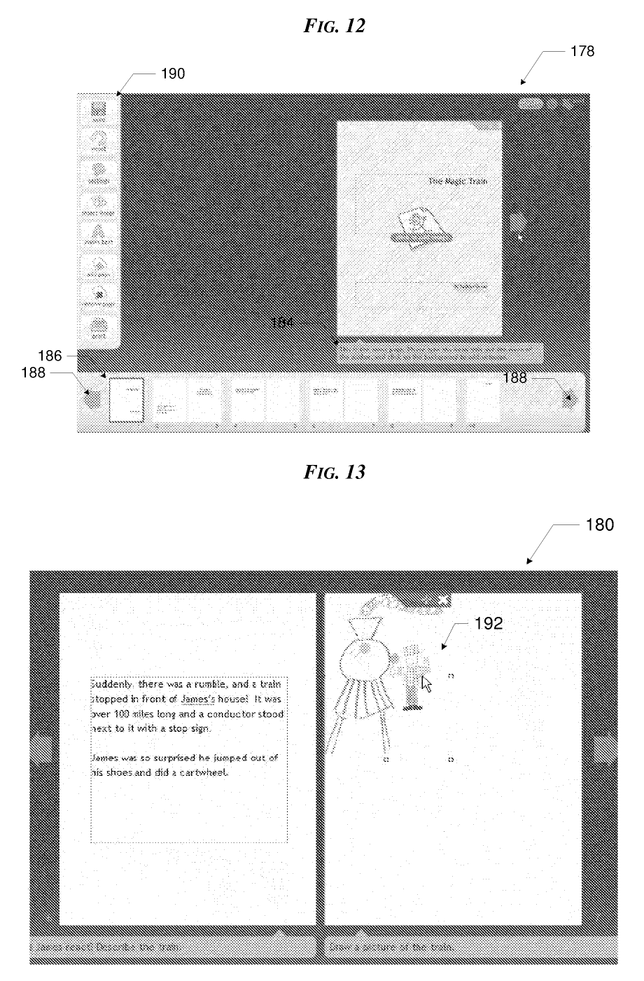

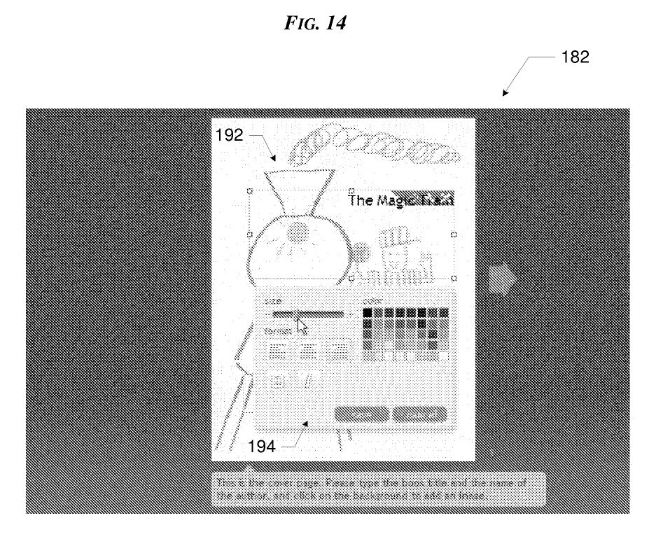

FIGS. 4-14 illustrate an exemplary embodiment of the child 12 creating a book using the functionality provided by the server 18. Although FIGS. 4-14 are described with reference to the elements included in the embodiment of a book creation system shown in FIGS. 1-3, this or a similar process, including the same, more, or fewer elements, reorganized or not, can be performed using the system 10 or using another, similar system, as will be appreciated by a person skilled in the art.

In use, as shown in FIG. 4, a book creation process 70 can include identification 72 of a user who desires to create a book through a website associated with the server 18. As discussed above, in this embodiment, the user is the child 12. The child 12 can access the server 18 through a GUI at the client terminal 16 using a web browser, as will be appreciated by a person skilled in the art. When the child 12 first accesses the server 18, the interpolation engine 24, via the server 18, can query the child 12 for basic information in a new user questionnaire that can be used to initially create 74 the child's user profile 54, as discussed above. FIG. 5 illustrates an exemplary embodiment of a page 100 of a new user questionnaire including a registered user type, which can be child or adult. If “adult” is chosen, additional choices can be presented in a drop-down or other type of menu to further identify the adult, e.g., as a parent, grandparent, aunt or uncle, journalist, blogger, publisher, teacher, or other adult assisting a child or desiring to create a book themselves. When the child 12 subsequently logs on to the server 18 in another browsing session, the interpolation engine 24 can retrieve from the user profile database 30 data entered in the new user questionnaire and stored in the child's user profile 54. After completing the new user questionnaire, in the same or subsequent browsing session, the child 12 can have the option of adding or changing basic information, such as new interests, a new geographic location, and/or other keywords to help better define the child's interests and to help the interpolation engine 24 better target generated content for the child 12.

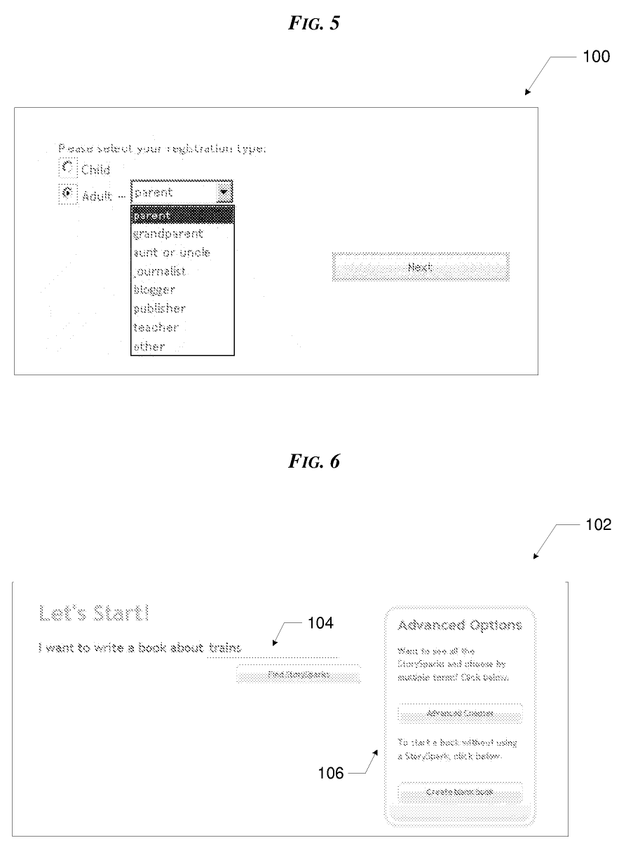

Logged on to the server 18 through the client terminal 16, the child 12 can be presented with a plurality of options, such as browsing completed stories in the completed stories database 34, leaving comments or sending feedback to authors of completed stories, resuming writing a book previously created and stored as partially complete in the completed stories database 34, and creating a new book. If the child 12 chooses to create a new story, the server 18 can receive 76 a story query from the child 12 including a desired subject of the new story. FIG. 6 shows an exemplary embodiment of an initial story creation page 102 that the child 12 can see via GUI upon selecting to write a new story. The child 12 can fill in a blank 104 with a desired story subject, or the child 12 can select an advanced option 106, such as seeing a list of multiple story subjects to choose from, being able to enter in a plurality of desired story subjects, and creating a blank book, e.g., a book without a story starter generated by the generation engine 28.

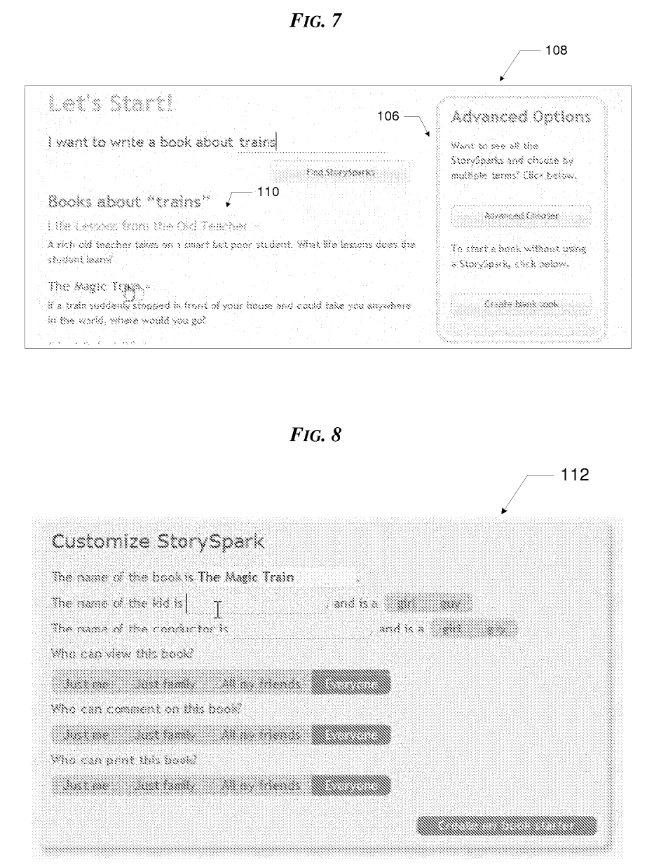

If the child 12 fills in the blank 104 with a desired story subject or otherwise communicates desired story subjects to the server 18, the generation engine 28 can generate 78, as discussed above, one or more story plots for the child 12 using the child's user profile 54, which now at least temporarily includes the submitted desired story subject(s). As shown in an exemplary embodiment of a story ideas page 108 in FIG. 7, one or more story plots 110 selected from the story plots library 38 by the generation engine 28 can be transmitted and displayed 80 to the child 12. The story plots 110 can be displayed textually and/or graphically (e.g., depending on the user's learning level) and can include story plot titles and/or short story plot summaries. The story ideas page 108 can include the advanced option 106 choices discussed above to provide flexibility in story creation and allow the child 12 to make advanced story choices or begin a story on their own. On the story ideas page 108, the child 12 can select one of the provided story plots 110, such as by clicking on one of the story plot titles, and the server 18 can receive 82 the child's story plot selection via the network 20. Based on the selected story plot and/or on the child's user profile 54, the generation engine 28 can generate 84 story prompts to help flesh out the selected story plot and receive 86 the child's responses to the prompts. FIG. 8 illustrates an exemplary embodiment of a story prompts page 112 that the child 12 can fill out with basic story information such as a book title, a name for each of the book's characters, a gender of each of the book's characters, the story's geographic setting, etc. and story distribution information such as who can view the eventually created book through the website associated with the server 18 (e.g., only the child 12, only users designated by the child 12 such as family members or friends, everyone, etc.). The basic information choices presented on the story prompts page 112 can include one or more story elements that the generation engine 28 selects from the story elements database 40 based on the child's user profile 54. The child 12 can have the option of choosing one or more of the presented story elements for inclusion in their story. The child 12 can also have the option to make no basic story information choices. In other words, the child 12 can choose to have the interpolation engine 24 generate a story starter based on the child's user profile 54 without additional information, e.g., data acquired through the story prompts page 112.

At any stage of the book creation process, the child 12 can choose to change his or her story by having a different plot or one or more different story elements, using less story structure, receiving less instructional guidance, etc. The generation engine 28 can react to such user choices by generating a new story starter for the child 12, reducing or increasing the amount of instructional text provided to the child 12 on each page of the story-in-progress, and otherwise changing the information provided to the child 12 from the libraries 36. The generation engine 28 can record such user choices in the child's user profile 54 to help the generation engine 28 make better selections in the libraries 36 for the child 12 in the future regarding the current book-in-progress or other activity. For example, if the child 12 routinely chooses to write a story with less textual instruction, the generation engine 28 can conclude that the child 12 is a more experienced storyteller and can accordingly increase the child's learning level profile 56.

The generation engine 28 can create 88 a story starter as discussed above using the child's user profile 54, selected story plot, selected story elements, and/or other basic story information. Generally, the generation engine 28 can query one or more of the libraries 36 for one or more targeted media items related to the child's selected story plot, such as story elements from the story elements database 40, drawing guidance text from the drawing guidance library 46, writing guidance text from the instructional elements library 42, suggested illustrations from the images library 44, illustration inspiration pages from the drawing page inspirations library 48, etc. In an exemplary embodiment, the generation engine 28 selects a plurality of targeted media items from each of the libraries 36 it queries to help guide the child 12 in writing a story while allowing the child 12 to make creative choices, encouraging use of his or her own creative voice, and teaching the child 12 that different effective approaches can be taken to reach the goal of writing a story. For example, the generation engine 28 can select a plurality of drawings from the drawing page inspirations library 48 to show the child 12 that there are many ways to draw or represent an element and to minimize influence on the child's original visual style. Also as mentioned above, the generation engine 28 can evaluate the child's level of experience with book skeletons in general as reflected in the child's learning level profile 56 and/or community interaction as reflected in the child's taste profile 58 and determine the level of detail appropriate for the child's story starter. In this way, the generation engine 28 can select the potentially most useful media items for the child 12 to help the child 12 successfully write a complete story and to learn, develop, and grow as a writer. For example, the generation engine 28 can determine an appropriate number of plot beats for the story based on the child's user profile 54. The higher the child's storytelling ability, e.g., the higher the child's learning level, the fewer plot beats provided in the story starter with associated instructional text and/or images. Beginning storytellers will often write stories characterized by high sensory detail but having illogical sequences of events with no conclusion, and providing a higher number of plot beats to beginning storytellers can allow the user to describe in detail characters, settings, etc. and write about non-critical story events while pushing the user to consider how earlier events in the story can lead to a story conclusion.

The child 12 can be provided 90 with an option on a GUI at the client terminal 16 to edit the story starter generated by the generation engine 28 either online, e.g., using the client terminal 16 while in electronic communication with the server 18, or offline, e.g., printed on paper or using the client terminal 16 without electronic communication with the server 18. Whichever the choice, the child 12 can edit 92 the story at the child's own pace.

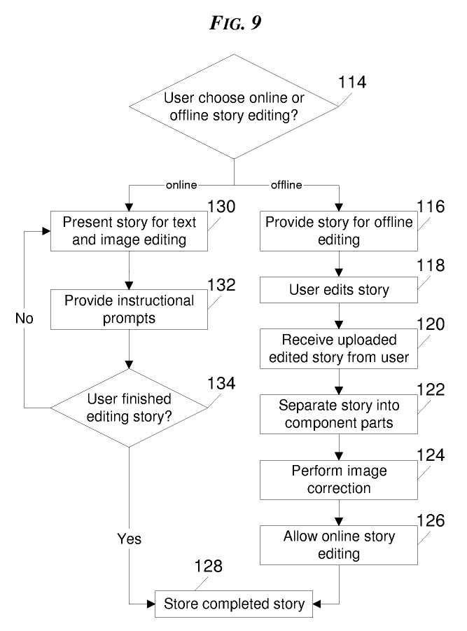

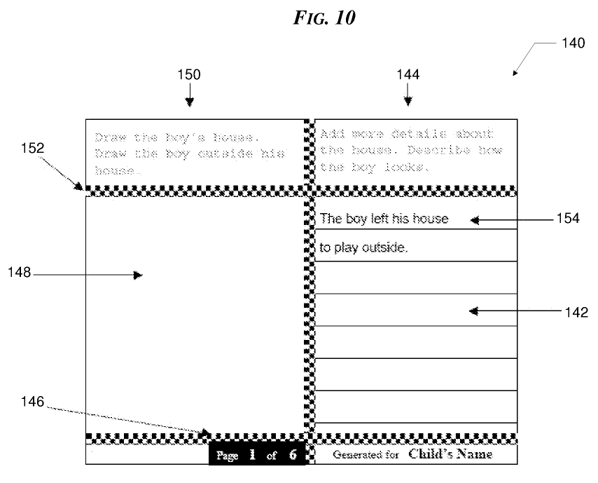

FIG. 9 illustrates exemplary embodiments of online and offline story editing approaches. If the child 12 chooses 114 offline editing, the server 18 can provide 116 the story to the child 12 via the network 20 and the client terminal 12 for offline retrieval, e.g., for printing on the printer 22, for editing while the client terminal 16 is not in communication with the network 20, etc. The story provided to the child 12 can be essentially the same story that would be provided to the child 12 in online editing, generally including the story starter and any information gathered by the generation engine 28 from one or more of the libraries 36. While the child 12 edits 118 the story offline, the server 18 idles with respect to the client terminal 16 (except if, e.g., another user accesses the server 18 using the client terminal 16 or the child 12 accesses the server 18 for other activity such as reading other users' completed stories).

FIG. 10 illustrates an exemplary embodiment of a printed story page 140 that the server 18 can transmit to the client terminal 16 and that the child 12 can print using the printer 22 for offline editing. The printed story page 140 can include a variety of elements including the same, more, or less than those shown in FIG. 10. As illustrated, the printed story page 140 includes a story text area 142 where the child 12 can write story text. Instructional writing text can be provided in a writing guide area 144 adjacent to the story text area 142 to help the child 12 determine what to write on this page in this stage of the story. The child 12 can identify the story stage by looking in a page number area 146 indicating a total number of pages in the generated book skeleton and which page is shown in the printed story page 140. The child 12 can provide illustrations in a drawing area 148 adjacent to the story text area 142. Instructional drawing text can be provided in a drawing guide area 150 adjacent to the drawing area 148 to help the child 12 determine appropriate visuals. Depending on the generation engine's processing and/or the child's chosen options, the story text area 142 and/or the drawing area 148 can be empty of text and/or images, or one or both of the areas 142, 148 can include story elements such as suggested images or suggested text 154. The various areas of the printed story page 140 can be separated with dividers 152, which can be checkerboard-patterned lines as shown or any other type of divider. The dividers 152 can help highlight various story parts to the child 12 as well as help the server 18 interpret the printed story page 140 if and when the child 12 uploads the printed story page 140 to the server 18.

At any stage of completion of adding text and/or drawings to the printed story page 140, the child 12 can upload the printed story page 140 (and any number of other printed story pages) to be received 120 by the server 18. The printed story page 140 can be uploaded to the server 18 in a variety of ways appreciated by a person skilled in the art, such as by taking a digital photograph of the printed story page 140 using a camera in communication with the client terminal 16 or by scanning the printed story page 140 with a scanning device in communication with the client terminal 16, and transmitting the page image from the client terminal 16 to the server 18 via the network 20.

The interpolation engine 24 can analyze and/or manipulate the uploaded page image in any number of ways before and/or after storing the printed story page 140 in the completed stories database 34. For example, the interpolation engine 24 can separate 122 parts of the page image into story components that generally correspond to the printed story page's areas. The interpolation engine 24 can identify the dividers 152 to help separate the page image into component parts, such as by separating the drawing area 148 into an individual image, separating the story text area 142 into an individual image and/or conversion into text, discarding guidance text in the writing guide area 144 and the drawing guide area 150, and discarding any other unnecessary information in the page image. As another example, the interpolation engine 24 can perform 124 image correction of a drawing retrieved from the drawing area 148 to help improve picture quality (e.g., lighting, color, etc.) and/or picture size.

The server 18 can allow 126 the child 12 to edit the uploaded story page (and any other uploaded story pages) online, as discussed further below. The completed story (or partially finished story) can be stored 128 in the completed stories database 34 when the child 12 indicates he or she is done editing the story, as the child 12 finishes editing each page, or with any other frequency as will be appreciated by a person skilled in the art.

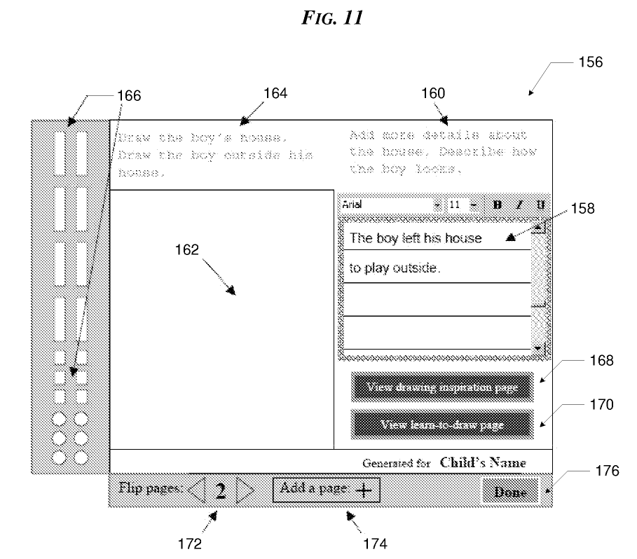

If the child chooses 114 online rather than offline editing, the server 18 can provide 130 the story to the child 12 on the client terminal 16 via the network 20. FIG. 11 illustrates an exemplary embodiment of an online story page 156 that the child 12 can edit via client terminal GUI. The online story page 156 can include a variety of elements including the same, more, or less than those shown in FIG. 11. The online story page 156 is generally similar to the printed story page 140 discussed above. As illustrated, the online story page 156 includes a text editor area 158 similar to a word processing area where the child 12 can write story text and change the appearance of story text (e.g., font style, font size, font color, italics, etc.). Instructional writing text can be provided in a writing guide area 160 adjacent to the text editor area 158 to help the child 12 determine what to write on this page in this stage of the story. The child 12 can provide illustrations in a drawing area 162 adjacent to the text editor area 158. Instructional drawing text can be provided in a drawing guide area 164 adjacent to the drawing area 162 to help the child 12 determine appropriate visuals. A drawing application 166 can also be provided on the online story page 156 to provide online drawing shapes, clip art, and other tools that the child 12 can use to electronically draw pictures in the drawing area 162. The online story page 156 can provide 132 additional instructional assistance by, at any point in the story editing process, allowing the child 12 to click on a drawing inspiration button 168 and/or a learn-to-draw button 170 to respectively access drawing inspirations gathered by the generation engine 28 from the drawing page inspirations library 48 and learn-to-draw pages from the learn-to-draw pages library 50. Also at any point in the story editing process, the child 12 can browse story pages using browse buttons 172 and/or add a page to the story using an add-a-page button 174. In this way, the child 12 can easily determine what happened in the story before and/or after what is shown on the currently viewed online story page 156. The client terminal GUI can optionally display more than one page at a time.

The child 12 can click on a done button 176 to indicate 134 that he or she is done editing the story, either because the story is complete or because the child 12 is done with this editing session although the story is not yet finished. The completed story (or partially finished story) can be stored 128 in the completed stories database 34 when the child 12 clicks the done button 176, as the child 12 finishes editing each page, or with any other frequency as will be appreciated by a person skilled in the art.

FIGS. 12-14 illustrate alternative embodiments of online editing pages 178, 180, 182. Through a cover editing page 178, the child 12 can create a book cover page and enter, e.g., a book title, an author name, and a cover image. Instructional text 184 and/or an instructional drawing can be generated and provided on the cover editing page 178 by the generation engine 28. A navigational menu 186 can allow the child 12 to preview a plurality of the story's pages, to “jump” to any of the pages by clicking on the page preview, and to scroll through the story's pages using navigational arrow buttons 188. Activating a navigational arrow button 188 can flip a page with or without a motion-effect simulating turning of a paper page. An editing menu 190 can provide clickable button editing options, such as zooming into or out of book pages, saving the story, resetting the story to a beginning or other previously saved state, editing settings, inserting an image, inserting text, adding a story page, removing a story page, and printing one or more story pages. First and second story editing pages 180, 182 can allow the child 12 to edit various pages of the story with text and/or images and can include a navigational and/or an editing menu. The first story editing page 180 shows an uploaded hand-drawn illustration 192 being added to and arranged on the page. The second story editing page 182 shows the hand-drawn illustration 192 moved to the story's cover page and being edited using a drawing editing toolkit 194.

Whether the child 12 edited the story online or offline, the server 18 can display 94 the completed story to the child 12 via the client terminal GUI. The child 12 can choose to further edit the story. Any number of pages can be displayed at a time.

Once the child 12 indicates that the story is complete, the server 18 can save the story as a completed story in the completed stories database 34 and allow sharing 96 of the story with any users having appropriate permission as selected by the child 12, as discussed above. In this way, the completed story can be included in an online community of users and stories that can help create a culture of peer support so users and help other users create their own books.

The online community can be maintained by the server 18 as a bulletin board or other community structure including a variety of features, such as allowing private groups, e.g., invitation-only online groups for family and friends of a user to post and share books, create books together, plan book-centered events, and conduct online discussions, and allowing public groups, e.g., Internet-based online groups for the users to meet other users that share the same interests, post and share books, conduct online discussions, rate or comments on books, offer help and advice, and plan book-centered events. The online community can also allow users to browse and/or search for books in the completed stories database 34 in any way appreciated by a person skilled in the art, such as by author information (e.g., age, gender, etc.), book information (e.g., title, text, date created, etc.), illustration style (e.g., drawing, painting, etc.), interest group a book is associated with, story plot a story was created from, book popularity (e.g., community rating, number of views, number of comments, etc.), tags, keywords, etc. Server-side moderation of the online community can be allowed such that moderators can edit, approve, or disapprove books' text, books' illustrations, books' comments, etc. In this way, content in the community can be better maintained. The server 18 can also generate and maintain statistics regarding the online community, groups, and/or individual users that moderators can access to learn about a user's story starter usage pattern, a user's or group's activity in the community, story or user popularity in the community, and a user's or group's progress over time in story creation.

The server 18 via the assessment engine 26 can, as discussed above, generate 97 reporting information about the child 12 using the child's completed story, e.g., by analyzing a complexity of the book, an amount of time it took the child 12 to write the book, etc., and provide 98 the report to the child 12 and/or the adult 14 at the client terminal 16.

The child 12 can choose to print a completed story written by the child 12 and/or another user locally, e.g., client-side using the printer 22, or remotely, e.g., server-side. If the child 12 chooses to print the story remotely, the server 18 can convert the completed story into a PDF document, ready for printing in a book-production facility. The server 18 can load all relevant media files from one or more of the appropriate databases 30, 32, 34 and libraries 36, optimize the media files for professional printing, package all needed fonts, and generate a production-ready PDF file. A remotely printed book can be mailed to the child 12 at an address provided by the child 12 as part of the new user questionnaire or upon request for remote printing.

The screens discussed with reference to FIGS. 5-8 and 10-14 are not limited to any particular layout or configuration and can include the same, more, or fewer elements than those shown, reorganized or not. For example, manipulation tools such as pulldown menus, tabs, buttons, selection boxes, and scrollbars can be implemented using any one or more similar types of manipulation tools. Furthermore, two or more screens can be combined and presented on a single screen, and one screen can be divided into two or more screens. There can also be additional screens. Users can manipulate the screens in any way, e.g., using a mouse, a touch screen, a stylus, keyboard commands, etc. For example, a user can move his or her mouse pointer over an icon and click on the icon to access a particular functionality.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

1. A digital device, comprising:
a processor configured to execute instructions; and
a memory storing instructions capable of causing the processor to:
identify a user with user information,
using the user information, select at least one story plot outline from a first library of data including a plurality of story plot outlines,
using the user information, select at least one story detail element from a second library of data including a plurality of story detail elements that can be used in a story plot, and
providing the at least one story plot and the at least one story detail element to the user to allow the user to create a story using the at least one story plot and the at least one story detail element.

2. The digital device of claim 1, wherein the at least one story plot and the at least one story detail element are provided to the user over at least one network.

3. The digital device of claim 1, wherein the memory further stores instructions capable of causing the processor to assess a learning level of the user, wherein the user information includes the learning level of the user.

4. The digital device of claim 1, wherein the memory further stores instructions capable of causing the processor to select at least one instruction from a third library of data including a plurality of instructions instructing a user how to incorporate a selected story detail element into a selected story plot, and to provide the at least one instruction to the user.

5. The digital device of claim 4, wherein the at least one instruction corresponds to a learning level of the user.

6. The digital device of claim 1, wherein the memory further stores instructions capable of causing the processor to select at least one drawing instruction from a third library of data including a plurality of drawing instructions regarding story illustrations, and to provide the at least one drawing instruction to the user.

7. The digital device of claim 1, wherein the user information includes active identification information regarding a user input at a client terminal in electronic communication with the processor.

8. The digital device of claim 7, wherein the active identification information comprises at least one of an age of the user, a grade level of the user, a gender of the user, and a favorite book of the user.

9. The digital device of claim 1, wherein the user information includes passive identification information regarding a user's use of a website associated with the processor.

10. The digital device of claim 9, wherein the passive identification information comprises at least one of a complexity of a book created by the user, a number of books created by the user using the website, and a number of times at least one other user has accessed through the website a book created by the user.

11. The digital device of claim 10, wherein the memory further stores instructions capable of causing the processor to determine the complexity of the book created by the user based on at least one of book length, a vocabulary level of the book, a ratio between text provided by the user and text provided to the user, and a density of paragraphs in the book.

12. The digital device of claim 9, wherein the memory further stores instructions capable of causing the processor to generate a summary report of the passive information.

13. The digital device of claim 12, wherein the memory further stores instructions capable of causing the processor to display the summary report on a graphical user interface.

14. The digital device of claim 1, wherein the memory further stores instructions capable of causing the processor to allow the user to add at least one illustration to a story created by the user.

15. The digital device of claim 1, wherein the memory further stores instructions capable of causing the processor to allow accessibility of a story created by the user through a website associated with the processor.

16. A method, comprising:
receiving active identification information regarding a user, the active identification information including information regarding the user input at a client terminal through a website;
gathering passive identification information regarding the user, the passive identification information including statistics regarding the user's use of the website;
using the active and passive identification information, generating an outline for a story using a processor in electronic communication with the client terminal;
providing the outline to the user through the website; and
allowing the user to create a story using the outline.

17. The method of claim 16, further comprising generating a user profile using the active and passive identification information and using the user profile to generate the outline for the story.

18. The method of claim 17, wherein the user profile includes a learning level of the user, the learning level of the user based on at least one of an age of the user, a grade level of the user, a complexity of a book created by the user, a number of books created by the user using the website, and a number of times at least one other user has accessed through the website a book created by the user.

19. The method of claim 17, wherein the user profile includes a taste profile of the user, the taste profile of the user based on at least one of a subject of a book created by another user and accessed by the user through the website, a book identified as a favorite book of the user, a subject of a book created by the user, and a number of illustrations in a book created by the user.

20. The method of claim 16, further comprising, using the active and passive identification information, selecting at least one story element that can be inserted into the outline, and providing at least one instruction to the user regarding incorporation of the at least one story element into the outline.
